(19) United States
(12) Patent Application Publication
(10) Pub. No.: US 2024/0377301 A1
(43) Pub. Date: Nov. 14, 2024

(54) METHOD AND SYSTEM FOR ANALYZING PROCESS LOAD OF CAR BODY RACK WAREHOUSE

(71) Applicants: AUTOMOTIVE ENGINEERING CORPORATION, Tianjin (CN); SCIVIC ENGINEERING CORPORATION, Luoyang (CN)

(72) Inventors: Bing RUAN, Tianjin (CN); Yeqing WAN, Tianjin (CN); Rong ZHOU, Tianjin (CN); Yuancheng ZHANG, Tianjin (CN); Guojie LI, Tianjin (CN)

(73) Assignees: AUTOMOTIVE ENGINEERING CORPORATION, Tianjin (CN); SCIVIC ENGINEERING CORPORATION, Luoyang (CN)

(21) Appl. No.: 18/518,910

(22) Filed: Nov. 24, 2023

(30) Foreign Application Priority Data
May 9, 2023 (CN) 202310512003.2

(51) Int. Cl. G01N 3/20; B65G 1/04

(52) U.S. Cl. CPC G01N 3/20; B65G 1/0478; B65G 2201/0294

(57) ABSTRACT

Disclosed are a method and a system for analyzing a process load of a car body rack warehouse. The method includes the following steps: collecting initial geometric dimension data of a goods case and the maximum stock mass of the goods case; unifying units of the initial geometric dimension data of the goods case to form second geometric dimension data of the goods case, obtaining the maximum stock weight of the goods case by calculation; determining a goods case length, a goods case width, and a goods case height; calculating a mean value, a standard deviation, and a coefficient of variation of the maximum stock weight of the goods case; determining a process variable load of a car body rack according to a high tantile with the reliability of 0.95. The process variable load of the rack warehouse may be accurately quantified, thereby guiding the engineering design.

### CROSS-REFERENCE TO RELATED APPLICATIONS

This application claims priority to Chinese Patent Application No. 202310512003.2, filed on May 9, 2023, which is incorporated herein by reference in its entirety.

### TECHNICAL FIELD

The application relates to a method and a system for analyzing a process load of a rack-warehouse integrated steel structure house, and in particular to a method and a system for analyzing a process load of a car body rack warehouse.

### BACKGROUND

A warehouse-rack integrated steel structure house is a structural form that combines a steel structure three-dimensional rack and a steel structure warehouse into one, that is, a building house that combines a process apparatus and a building house, which may give full play to the advantages of high storage capacity and high cost performance of a stereoscopic warehouse, and has been widely welcomed in domestic and foreign markets in recent years. However, this new structural form is still in the stage of development, the design of a warehouse-rack integrated steel structure warehouse structure is not yet mature, and the relevant domestic norms need further improvement.

A car body warehouse-rack structure of a car factory bears a permanent load and a variable load, and the permanent load is easily calculated according to a weight of a building structure material. The warehouse-rack integrated variable load may also be classified into two parts: a general load acting on the outside of the structure, including a wind load, a snow load, an earthquake load, a roof live load, etc., and a process load acting on the inside of the warehouse-rack structure, including a pallet load, a goods load, a device load, etc.

However, there is no mature method for the process load acting on the inside of the warehouse-rack integrated structure, which also brings certain difficulties to the engineering construction. How to accurately quantify the process load for guiding the reliability design of the rack structure has become an urgent problem to be solved.

### SUMMARY

The application aims to provide a method and system for analyzing a process load of a car body rack warehouse, which may accurately quantify the process load for guiding the engineering design.

In order to achieve the above objective, the application adopts the following technical solution.

A method for analyzing a process load of a car body rack warehouse includes the following steps.

At S1, sample data of car body rack warehouses of i car factories is collected, the sample data including initial geometric dimension data of a goods case and the maximum stock mass Mᵢ of the goods case.

At S2, units of the initial geometric dimension data of the goods case are unified to form second geometric dimension data of the goods case, the second geometric dimension data of the goods case including transverse column spacing Lᵢ, longitudinal column spacing Bᵢ, and a floor height Hᵢ, units of the maximum stock mass of the goods case are unified, and the maximum stock weight Gᵢ of the goods case is obtained by calculation.

At S3, mean values, standard deviations, and coefficients of variation of geometric dimensions of the goods case are calculated through the second geometric dimension data of the goods case, and a goods case length L′, a goods case width B′, and a goods case height H′ are determined through the mean value.

$${L}^{′} = {μ}_{L} = \frac{1}{n} {\sum }_{i = 1}^{n} {L}_{i}$$

$${B}^{′} = {μ}_{B} = \frac{1}{n} {\sum }_{i = 1}^{n} {B}_{i}$$

$${H}^{′} = {μ}_{H} = \frac{1}{n} {\sum }_{i = 1}^{n} {H}_{i}$$

Where μ_{L} is a mean value of the transverse column spacing, μ_{B} is a mean value of the longitudinal column spacing, μ_{H} is a mean value of the floor heights, and n is the number of car body rack warehouses of different car factories:

At S4, a mean value μ_{G}, a standard deviation σ_{G}, and a coefficient of variation δ_{G} of the maximum stock weight of the goods case are calculated through the maximum stock weight of the goods case.

At S5, each coefficient of variation is compared with a coefficient of variation threshold δₘ, if each coefficient of variation is ≤δₘ, then the sample data of the car body rack warehouse meets a normal distribution condition, and a process variable load of a car body rack is determined according to a high tantile with the reliability of 0.95.

Gₖ=μ_{G}+1.645σ_{G}

Further arrangement is made as follows: at S6, in a case where an action manner of the process variable load on the goods case includes two manners, namely a concentrated load and a uniform load, a concentrated force Qₖ of a fulcrum and a standard value qₖ of a uniform line load are respectively calculated.

The concentrated force of the fulcrum is calculated according to the concentrated load.

$${Q}_{k} = {G}_{k} / 4$$

A standard value of a uniform surface load is calculated according to the uniform load.

$${q}_{0 k} = \frac{{G}_{k}}{{B}^{′} {L}^{′}}$$

The standard value of the uniform line load to a bearing beam on both sides is obtained through derivative calculation of a surface load.

$${q}_{k} = {q}_{0 k} {B}^{′} / 2$$

At S7, optimization design is performed, that is, according to a bending moment equivalence principle and/or a deflection equivalence principle, an action position of the concentrated force is determined with reference to the action of the uniform load.

A process of determining the action position of the concentrated force according to the bending moment equivalence principle is as follows.

Firstly, a bending moment of the bearing beam in two manners of load transfer, namely the uniform load and the concentrated load, is calculated.

A bending moment M_{Q} of the bearing beam is calculated according to the concentrated load.

$${M}_{Q} = {L}_{a} {Q}_{k}$$

Where Lₐ is a distance between any leg and a rack column in a length direction of a body.

A bending moment Mq of the bearing beam is calculated according to the uniform load.

$${M}_{q} = \frac{{q}_{k} {L}^{′2}}{8}$$

Then, M_{Q}=M_{q}, a critical point of the bending moment is obtained by calculation, a reasonable action position of the concentrated force is determined, at this time, the bending moment of the bearing beam corresponding to the concentrated force and the bending moment of the bearing beam corresponding to the uniform load are the same.

A process of determining the action position of the concentrated force according to the deflection equivalence principle is as follows.

Firstly, a deflection of the bearing beam in two manners of load transfer, namely the uniform load and the concentrated load, is calculated.

A deflection of the bearing beam is calculated according to the concentrated load.

$${f}_{Q} = \frac{{Q}_{k} {L}_{a} {L}^{′2}}{24 E I} ( 3 - 4 \frac{{L}_{a}^{2}}{{L}^{′2}} )$$

A deflection of the bearing beam is calculated according to the uniform load.

$${f}_{q} = \frac{5 {q}_{k} {L}^{′2}}{384 E I}$$

Where E is an elastic modulus of the bearing beam, and I is a second moment of area of the bearing beam.

Then, f_{Q}=f_{q}, a reasonable action position of the concentrated force is obtained by calculation, at this time, the deflection of the bearing beam corresponding to the concentrated force and the deflection of the bearing beam corresponding to the uniform load are the same.

The method further includes the following step that: at S8, design parameters of the legs and optimal control positions are obtained, so that the bearing capacity and deflection of the bearing beam of the rack meet the requirements.

The mean value μ_{G}, the standard deviation σ_{G}, and the coefficient of variation δ_{G} are respectively calculated according to the following formulas.

$${μ}_{G} = \frac{1}{n} {\sum }_{i = 1}^{n} {G}_{i} \\ {σ}_{G} = \sqrt{\frac{1}{n} {\sum }_{i = 1}^{n} {( {G}_{i} - {μ}_{G} )}^{2}} \\ {δ}_{G} = \frac{{σ}_{G}}{{μ}_{G}}$$

Where Gᵢ is the maximum stock weight of the goods case in any car body rack warehouse.

The standard deviation and the coefficient of variation of the geometric dimensions of the goods case are respectively calculated according to the following formulas.

$${σ}_{L} = \sqrt{\frac{1}{n} {\sum }_{i = 1}^{n} {( {L}_{i} - {μ}_{L} )}^{2}} \\ {σ}_{B} = \sqrt{\frac{1}{n} {\sum }_{i = 1}^{n} {( {B}_{i} - {μ}_{B} )}^{2}} \\ {σ}_{H} = \sqrt{\frac{1}{n} {\sum }_{i = 1}^{n} {( {H}_{i} - {μ}_{H} )}^{2}} \\ {δ}_{L} = {σ}_{L} / {μ}_{L} \\ {δ}_{B} = {σ}_{B} / {μ}_{B} \\ {δ}_{H} = {σ}_{H} / {μ}_{H}$$

Where σ_{L}, σ_{B}, and σ_{H} are the standard deviations of the transverse column spacing, the longitudinal column spacing, and the floor height respectively, and δ_{L}, δ_{B}, and δ_{H} are the coefficients of variation of the transverse column spacing, the longitudinal column spacing, and the floor height respectively.

Preferably, the car body rack warehouse is provided with a plurality of goods cases, any goods case includes rack columns and the bearing beam, two legs being uniformly distributed on the bearing beam, a pallet for placing the car body being arranged on the legs, and the pallet being centered relative to the bearing beam.

The application further discloses a system for analyzing a process load of a car body rack warehouse for implementing the above method, which includes an input module, a calculation module, an optimization analysis module, and a visual output module.

The input module is configured to input initial geometric dimension data of a goods case and the maximum stock mass of the goods case of car body rack warehouses of different car factories to the calculation module.

The calculation module is connected to the input module, and is configured to calculate mean values, standard deviations, and coefficients of variation of geometric dimensions of the goods case and the maximum stock weight of the goods case, compare each coefficient of variation with a coefficient of variation threshold, and determine a process variable load of a car body rack according to a high tantile with the reliability of 0.95.

The optimization analysis module is connected to the calculation module, and is configured to determine, according to a bending moment equivalence principle and/or a deflection equivalence principle, an action position of a concentrated force with reference to the action of a uniform load, and perform optimization design on positions of legs.

The visual output module is connected to the optimization analysis module, and is configured to output a comparison diagram of a bending moment of the bearing beam and design parameters of the legs after optimization.

Compared with the related art, the application has the following beneficial technical effects.

The process variable load of the rack warehouse may be accurately quantified, the geometric dimensions of the goods case of the rack warehouse may be quantitatively analyzed, and optimization design is performed on the design parameters of rack load supporting points through a derivative calculation method of the load, thereby guiding the engineering design.

In conclusion, the method and the system may be used in the design of a warehouse-rack integrated steel structure house to ensure the safety, reliability and economy of the structure.

### BRIEF DESCRIPTION OF THE DRAWINGS

In order to more clearly illustrate the specific implementations of the application or the technical solutions in the related art, the drawings used in the description of the specific implementations or the related art will be briefly described below. It is apparent that the drawings described below are only some implementations of the application. Other drawings may further be obtained by those of ordinary skill in the art according to these drawings without creative efforts.

FIG. 1 is a section diagram of a car body rack warehouse to which the application is applicable.

FIG. 2 is a plane view of any goods case in a car body rack warehouse.

FIG. 3 is a sectional view of any goods case in a car body rack warehouse.

FIG. 4 is a diagram of a distribution probability of data represented by a root-mean-square value interval.

FIG. 5 is a schematic diagram of reliability design of engineering vibration.

FIG. 6 is a flowchart of a method for analyzing a process load of a car body rack warehouse disclosed in Embodiment 1.

FIG. 7 is a flowchart of a method for analyzing a process load of a car body rack warehouse disclosed in Embodiment 2.

FIG. 8 is a schematic diagram of each fulcrum subjected to a concentrated force.

FIG. 9 is a schematic diagram of a bearing beam subjected to a uniform line load.

FIG. 10 is a comparison diagram of a bending moment of a bearing beam in two manners of load transfer, where a dotted line shows a bending moment of the bearing beam calculated according to concentrated forces of two fulcrums, and a solid line shows a bending moment calculated according to a uniform distribution load.

FIG. 11 is a schematic diagram of extracting a root by a functional diagram method.

FIG. 12 is a structural block diagram of a system for analyzing a process load of a car body rack warehouse disclosed in Embodiment 3.

FIG. 13 is a structural block diagram of an electronic device.

### DETAILED DESCRIPTION OF THE EMBODIMENTS

The technical solutions of the application will be clearly and completely described in conjunction with the drawings. It is apparent that the described embodiments are only a part of the embodiments of the application, and not all of them. All other embodiments obtained by those of ordinary skill in the art based on the embodiments of the application without creative efforts are within the scope of the application.

In the description of the application, it is to be noted that the orientations or positional relationships indicated by the terms “upper”, “down”, “left”, “right”, “vertical”, “horizontal”, “inside”, “outside”, etc. are based on the orientations or positional relationships shown in the drawings, and are only for the convenience of describing the application and simplifying the description. The description does not indicate or imply that the device or element referred to must have a specific orientation, be constructed and operated in a specific orientation, and therefore cannot be construed as limiting the application. In addition, terms “first” and “second” are only used for describing purposes, and cannot be understood as indicating or implying relative importance.

In the description of the application, it is to be noted that, unless otherwise clearly specified and limited, the terms “installation”, “mutual connection”, “connection”, and other terms shall be understood in a broad sense. For example, the term may be a fixed connection or a detachable connection, or an integrated connection: the term may be a mechanical connection or an electric connection; and the term may be a direct connection or an indirect connection through an intermediary, and may be communication inside two components. The specific meaning of the above-mentioned terminology in the application may be understood by those of ordinary skill in the art in specific circumstances.

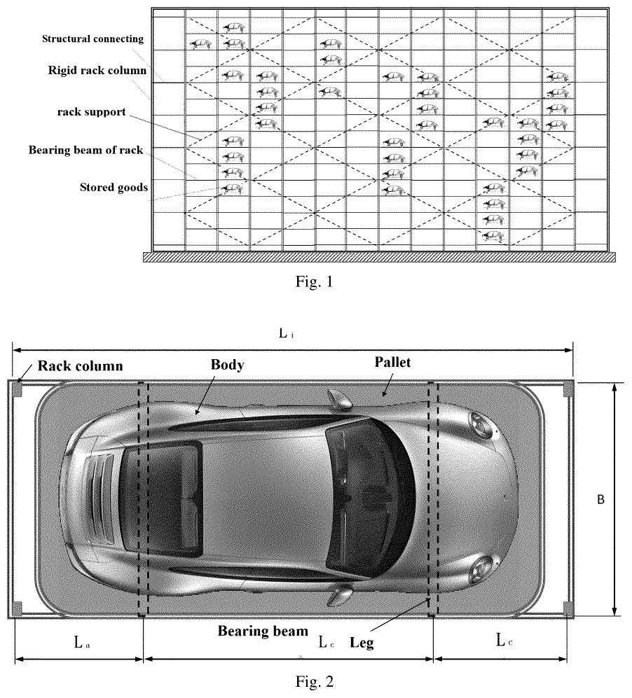

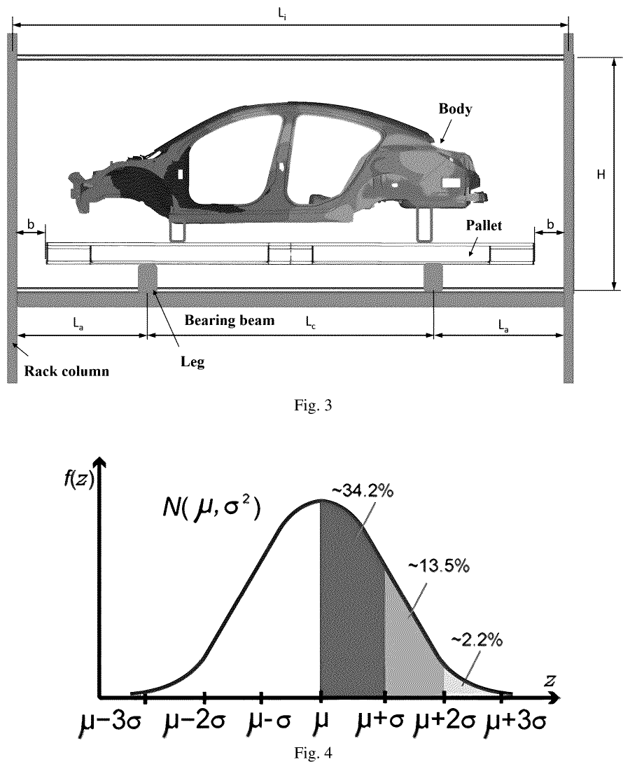

First, it is to be noted that, a method for analyzing a process load provided by the application is mainly applicable to a car body warehouse-rack integrated steel structure. As shown in FIG. 1, a car body warehouse-rack integrated house is provided with a plurality of goods cases, and a car body may be parked in any goods case. As shown in FIG. 2 and FIG. 3, any goods case includes rack columns and a bearing beam, two legs being uniformly distributed on the bearing beam, a pallet for placing the car body being arranged on the legs, and the pallet being centered relative to the bearing beam. For ease of description, the following parameters are defined: B is a distance between two adjacent rack columns in a width direction of the body (longitudinal column spacing), Lᵢ is a distance between two adjacent rack columns in a length direction of the body (transverse column spacing), L_{c} is a distance between the two legs, Lₐ is a distance between any leg and the rack column in the length direction of the body, b is a distance between the pallet and the shelf column, and H is a distance between the upper and lower bearing beam (floor height).

In order to enable those skilled in the art to better understand the application, a principle of statistics used by the application is first introduced: a random variable z follows a normal distribution with a mathematical expectation of μ and a variance of σ, denoted as N(μ, σ). A probability density function thereof is as follows.

$$f ( z ) = \frac{1}{σ \sqrt{2 π}} exp [ - \frac{{( z - μ )}^{2}}{2 {σ}^{2}} ]$$

A principle of an important property 3σ of the normal distribution is a distribution probability of data represented by a root-mean-square value interval, as shown in FIG. 4.

$$P ( μ - 1 σ ⩽ Z ⩽ μ + 1 σ ) = 68.26 \% \\ P ( μ - 2 σ ⩽ Z ⩽ μ + 2 σ ) = 95.44 \% \\ P ( μ - 3 σ ⩽ Z ⩽ μ + 3 σ ) = 99.73 \% \\ P ( Z ⩽ μ + 1.645 σ ) = 95 \% \\ P ( Z ⩽ μ + 2 σ ) = 97.73 \%$$

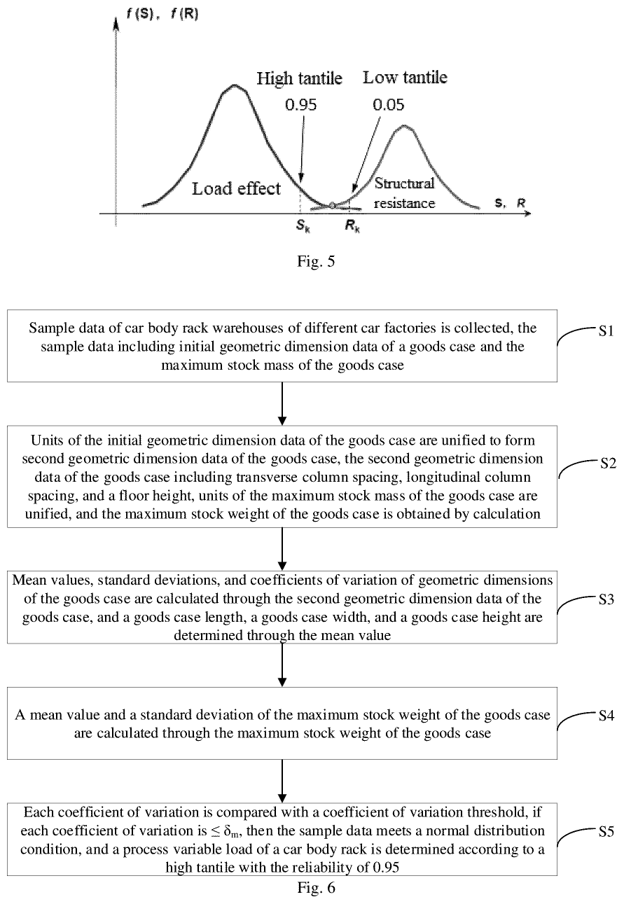

The main contents of reliability design of engineering vibration include: 1, statistical characteristics of a load effect and structural resistance: 2, reliability analysis of a component material and a structural system; and 3, determination of a reliability target of an engineering structure. A design principle of reliability design of engineering vibration is as shown in FIG. 5. A standard value of a process variable load generally takes a high tantile of the probability distribution, which is generally 0.95 internationally.

At this time, when the variable load Sₖ is normally distributed, the standard value of the variable load is as follows.

$${S}_{k} = {μ}_{s} + 1 \text{.645} {σ}_{s}$$

When the variable load Sₖ is lognormally distributed, the standard value is approximated as follows.

$${S}_{k} = {μ}_{s} exp ( - 1 \text{.645} {δ}_{s} )$$

Where μₛ, σₛ, and δₛ are a means value, a standard deviation, and a coefficient of variation of the material strength, respectively.

### Embodiment 1

Referring to FIG. 6, the application discloses a method for analyzing a process load of a car body rack warehouse, which includes the following steps.

At S1, as shown in Table 1 below, sample data of car body rack warehouses of i car factories is collected, the sample data including initial geometric dimension data of a goods case and the maximum stock mass Mi of the goods case.

TABLE 1
Sample Data of Car Body Rack Warehouse

| No | Manufacturer | Model | Lᵢ | Bᵢ | Hᵢ | Mᵢ |
|---|---|---|---|---|---|---|
| i | Name | Specification | mm | mm | mm | kg |
| 1 | Chery 1st | | 5750 | 2500 | 2810 | 950 |
| | ultimate factory | | | | | |
| 2 | Beijing Benz | X156 | 5450 | 2040 | 2810 | 770 |
| 3 | Leading Ideal | W01 | 6250 | 2480 | 2810 | 950 |
| 4 | NIO | W01 | 5640 | 2400 | 2810 | 900 |
| 5 | BMW | G38/G18 | 6250 | 2200 | 2410 | 900 |
| 6 | Mercedes Benz | W206 | 5500 | 2730 | 2920 | 1200 |
| | South Africa | | | | | |
| 7 | Mercedes Benz Russia | X167 | 6000 | 2600 | 3100 | 1200 |

At S2, units of the initial geometric dimension data of the goods case are unified to form second geometric dimension data of the goods case, the second geometric dimension data of the goods case including transverse column spacing Lᵢ, longitudinal column spacing Bᵢ, and a floor height Hᵢ, units of the maximum stock mass of the goods case are unified, and the maximum stock weight Gᵢ of the goods case is obtained by calculation.

At S3, mean values and coefficients of variation of geometric dimensions of the goods case are calculated through the second geometric dimension data of the goods case, and a goods case length L′, a goods case width B′, and a goods case height H′ are determined through the mean value.

$${L}^{′} = {μ}_{L} = \frac{1}{n} {\sum }_{i = 1}^{n} {L}_{i} = 5.834 ( m ) \\ {B}^{′} = {μ}_{B} = \frac{1}{n} {\sum }_{i = 1}^{n} {B}_{i} = 2.421 ( m ) \\ {H}^{′} = {μ}_{H} = \frac{1}{n} {\sum }_{i = 1}^{n} {H}_{i} = 2.810 ( m ) \\ {σ}_{L} = \sqrt{\frac{1}{n} {\sum }_{i = 1}^{n} {( {L}_{i} - {μ}_{L} )}^{2}} = 0.311 ( m ) \\ {σ}_{B} = \sqrt{\frac{1}{n} {\sum }_{i = 1}^{n} {( {B}_{i} - {μ}_{B} )}^{2}} = 0.218 ( m ) \\ {σ}_{H} = \sqrt{\frac{1}{n} {\sum }_{i = 1}^{n} {( {H}_{i} - {μ}_{H} )}^{2}} = 0.191 ( m ) \\ {δ}_{L} = {σ}_{L} / {μ}_{L} = 0.053 \\ {δ}_{B} = {σ}_{B} / {μ}_{B} = 0.09 \\ {δ}_{H} = {σ}_{H} / {μ}_{H} = 0.068$$

Where n is the number of car body rack warehouses of different car factories, in the embodiment, n=7, μ_{L} is a mean value of the transverse column spacing, μ_{B} is a mean value of the longitudinal column spacing, μ_{H} is a mean value of the floor heights.

In order to facilitate the subsequent calculation, the goods case length L′, the goods case width B′, and the goods case height H′ may be appropriately rounded.

$${L}^{′} = {μ}_{L} = 5.834 ( m ) \approx 6. ( m ) \\ {B}^{′} = {μ}_{B} = 2.421 ( m ) \approx 2.5 ( m ) \\ {H}^{′} = {μ}_{H} = 2.810 ( m ) \approx 2.8 ( m )$$

At S4, a mean value μ_{G}, a standard deviation σ_{G}, and a coefficient of variation δ_{G} of the maximum stock weight of the goods case are calculated through the maximum stock weight of the goods case.

$${μ}_{G} = \frac{1}{n} {\sum }_{i = 1}^{n} {G}_{i} = 9.81 ( kN ) \\ {σ}_{G} = \sqrt{\frac{1}{n} {\sum }_{i = 1}^{n} {( {G}_{i} - {μ}_{G} )}^{2}} = 1.49 ( kN ) \\ {δ}_{G} = {σ}_{G} / {μ}_{G} = 0.015$$

At S5, each coefficient of variation is compared with a coefficient of variation threshold δₘ, according to principle of statistics, if each coefficient of variation is ≤δₘ, then the sample data of the car body rack warehouse meets a normal distribution condition. δₘ=15%, according to the above calculated data, the coefficients of variation of the geometric dimensions of the goods case and the maximum stock weight of the goods case are no more than 15%, and the sample data basically meets the normal distribution condition.

A process variable load Gₖ of a car body rack is determined according to a high tantile with the reliability of 0.95.

$${G}_{{k}^{=}} {μ}_{G} + 1 \text{.645} {σ}_{G} = 1 2.27 ( kN ) \approx 12 ( kN )$$

The design load should be statistically analyzed and may be used in engineering under certain guaranteed probability conditions. Usually selecte typical probability distribution such as normal, lognormal and other distribution functions to fit, and the significance level of the test may be 0.05. The embodiment requires that: statistical parameters of the load, such as the mean value, standard deviation, coefficient of variation, etc., should be determined according to measured data and a parameter estimation method of mathematical statistics. This embodiment extracts the data samples in seven projects for statistical analysis, and finally quantifies the process variable load of the rack. The process variable load determined according to the high tantile with the reliability of 0.95 is in line with the standard for the reliability design of the projects.

### Embodiment 2

Referring to FIG. 7, the embodiment differs from Embodiment 1 in that the method further includes the following steps.

At S6, in a case where an action manner of the process variable load on the goods case includes two manners, namely a concentrated load and a uniform load, a concentrated force Qₖ of a fulcrum and a standard value qₖ of a uniform line load are respectively calculated.

As shown in FIG. 8, the car body is parked on the legs in the goods case, the weight of the body may be distributed to four fulcrums, and the concentrated force of each fulcrum is as follows.

$${Q}_{k} = {G}_{k} / 4 = 3 ( kN )$$

A standard value of a uniform surface load is calculated according to the uniform load.

$${q}_{0 k} = \frac{{G}_{k}}{{B}^{′} {L}^{′}} = \frac{12}{6 \times 2.5} = 0.8 ( kN / {m}^{2} )$$

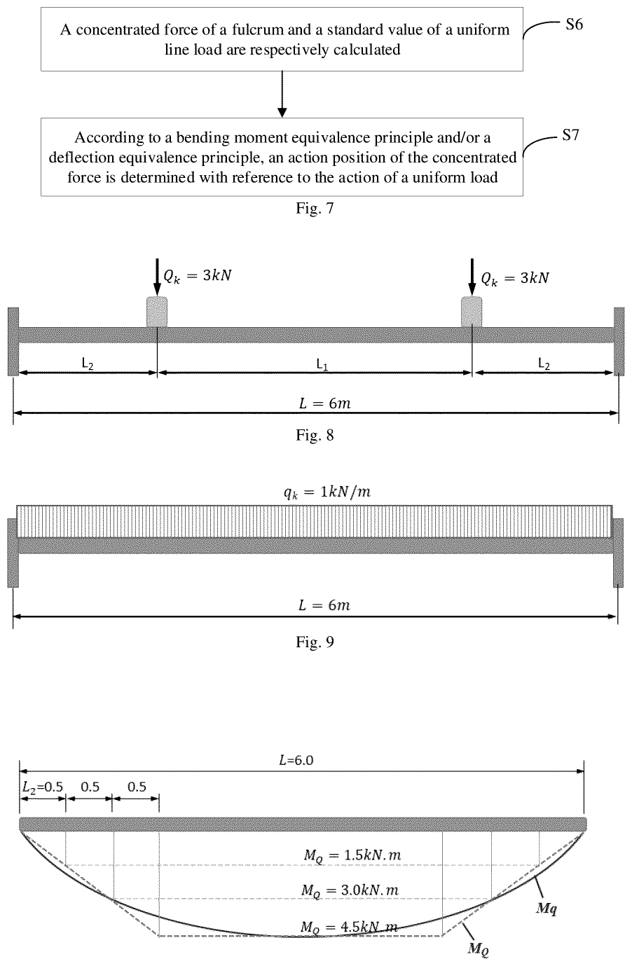

As shown in FIG. 9, the standard value of the uniform line load to the bearing beam on both sides is obtained through derivative calculation of a surface load.

$${q}_{k} = \frac{{q}_{0 k} {B}^{′}}{2} = \frac{0.8 \times 2.5}{2} = 1 ( kN / {m}^{2} )$$

At S7, optimization design is performed, that is, according to a bending moment equivalence principle and/or a deflection equivalence principle, an action position of the concentrated force is determined with reference to the action of the uniform load.

In the embodiment, a process of determining the action position of the concentrated force according to the bending moment equivalence principle is as follows.

Firstly, a bending moment of the bearing beam in two manners of load transfer, namely the uniform load and the concentrated load, is calculated.

A bending moment of the bearing beam is calculated according to the concentrated load.

$${M}_{Q} = {L}_{a} {Q}_{k} ;$$

Where Lₐ is a distance between any leg and a rack column in a length direction of a body.

A bending moment of the bearing beam is calculated according to the uniform load.

$${M}_{q} = \frac{{q}_{k} {L}^{′2}}{8}$$

Then, M_{Q}=M_{q}, a critical point of the bending moment is obtained by calculation, a reasonable action position of the concentrated force is determined, at this time, the bending moment of the bearing beam corresponding to the concentrated force and the bending moment of the bearing beam corresponding to the uniform load are the same.

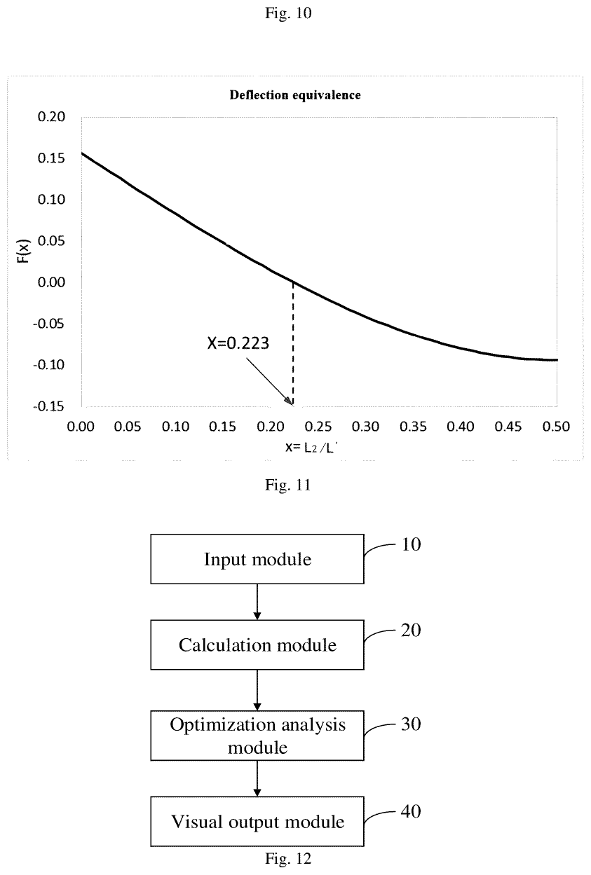

As shown in FIG. 10, a comparison diagram of the bending moment of the bearing beam in two manners of load transfer is output, if M_{Q}=M_{q}, when Lₐ=L′/4=1.5 m, the bending moment of the bearing beam corresponding to the concentrated force and the bending moment of the bearing beam corresponding to the uniform load are the same.

### Embodiment 3

In the embodiment, a process of determining the action position of the concentrated force according to the deflection equivalence principle is as follows.

Firstly, a deflection of the bearing beam in two manners of load transfer, namely the uniform load and the concentrated load is calculated.

A deflection of the bearing beam is calculated according to the concentrated load.

$${f}_{Q} = \frac{{Q}_{k} {L}_{a} {L}^{′2}}{24 E I} ( 3 - 4 \frac{{L}_{a}^{2}}{{L}^{′2}} )$$

A deflection of the bearing beam is calculated according to the uniform load.

$${f}_{q} = \frac{5 {q}_{k} {L}^{′2}}{384 E I}$$

Where E is an elastic modulus of the bearing beam, and I is a second moment of area of the bearing beam.

Then, f_{Q}=f_{q}, a cubic equation with one unknown may be obtained from the above two formulas.

$${X}^{3} - \frac{3}{4} X + \frac{5}{32} = 0 , where x = {L}_{a} / {L}^{′} .$$

Referring to FIG. 11, x=0.223 is obtained by using a graphing method, a reasonable action position of the concentrated force is Lₐ≈L′/4.5, at this time, the deflection of the bearing beam corresponding to the concentrated force and the deflection of the bearing beam corresponding to the uniform load are the same.

At S8, design parameters of the legs and optimal control positions are obtained, so that the bearing capacity and deflection of the bearing beam of the rack meet the requirements.

When L′=6 m, B′=2.5 m, it can be seen from a diagram of the bending moment of the concentrated force that the closer to both ends of the beam, the smaller the bending moment, and when M_{Q}≤M_{q}, L_{c}≤L′/4=1.5 m. It is known that Lₐ=L′−L_{c}, so that Lₐ≥L′/2=3 m.

When the concentrated force acts on the bearing beam, the closer to both ends of the beam, the smaller the deflection, and when f_{Q}≤f_{q}, Lₐ≤L′/4.5=1.33 m.

Considering the requirements for the bearing capacity and the deflection of the rack bearing beam, as well as the operation convenience of the actual engineering design, the legs should be arranged at quartile positions of the bearing beam, that is, Lₐ=1.5 m, and L_{c}=3 m, which are the optimal control positions of the legs.

In the application, optimization design is performed on the design parameters of rack load supporting points through a derivative calculation method of the load, thereby guiding the engineering design to ensure the safety, reliability and economy of the structure.

### Embodiment 4

Referring to FIG. 12, a system for analyzing a process load of a car body rack warehouse includes an input module 10, a calculation module 20, an optimization analysis module 30, and a visual output module 40. The input module 10 is configured to input initial geometric dimension data of a goods case and the maximum stock mass of the goods case of car body rack warehouses of different car factories to the calculation module 20.

The calculation module 20 is connected to the input module 10, and is configured to calculate mean values, standard deviations, and coefficients of variation of geometric dimensions of the goods case and the maximum stock weight of the goods case, compare each coefficient of variation with a coefficient of variation threshold, and determine a process variable load of a car body rack according to a high tantile with the reliability of 0.95.

The optimization analysis module 30 is connected to the calculation module 20, and is configured to determine, according to a bending moment equivalence principle and/or a deflection equivalence principle, an action position of a concentrated force with reference to the action of a uniform load, and perform optimization design on positions of legs.

The visual output module 40 is connected to the optimization analysis module 30, and is configured to output a comparison diagram of a bending moment of the bearing beam and design parameters of the legs after optimization.

The working principle and the specific implementation process of the system refer to the above method embodiment, and will not be elaborated herein.

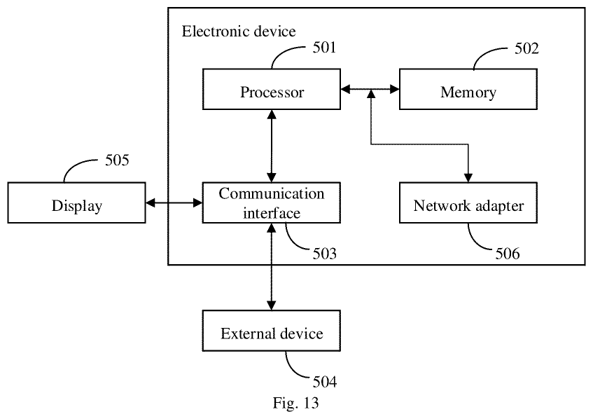

Referring to FIG. 13, the application further provides an electronic device. The electronic device includes one or more processors 501, a memory 502 configured to storing executable instructions of the processor 501, the memory 502 being electrically connected to the processor 501.

The processor 501 is configured to perform the method corresponding to the above method embodiment by executing the executable instructions, and the specific implementation process may refer to the above method embodiment, and will not be elaborated herein.

Optionally, the electronic device may further include a communication interface 503. The electronic device may communicate with one or more external devices 504 (such as a keyboard, a pointing device, a display 505, etc.) through the communication interface 503.

Optionally, the electronic device 600 may further include a network adapter 506. The electronic device may communicate with one or more networks (such as a Local Area Network (LAN), a Wide Area Network (WAN), and/or a public network, such as the Internet) through the network adapter 506.

The application further provides a computer-readable storage medium, on which a computer program is stored. When executed by a processor 501, the computer program implements the method corresponding to the above method embodiment, and the specific implementation process may refer to the above method embodiment, and will not be elaborated herein.

Finally, it is to be noted that the above embodiments are only intended to illustrate the technical solutions of the application, but not intended to limit the application. Although the application is described in detail with reference to the foregoing embodiments, it should be understood by those of ordinary skill in the art that: they may still make modifications to the technical solutions described in the foregoing embodiments or equivalence replacements to part or all of the technical features without any modification of the technical solutions or departures from the scope of the technical solutions of the embodiments of the application.

1. A method for analyzing a process load of a car body rack warehouse, performing the following steps through a processor comprising a computing device:
S1, collecting sample data of car body rack warehouses of i car factories, the sample data comprising initial geometric dimension data of a goods case and the maximum stock mass Mᵢ of the goods case by a user;
S2, forming a second geometric dimension data of the goods case, the second geometric dimension data of the goods case comprising transverse column spacing Lᵢ, longitudinal column spacing Bᵢ, and a floor height Hᵢ, unifying units of the maximum stock mass of the goods case, and converting mass to weight through standard gravitational relationships and obtaining the maximum stock weight Gᵢ of the goods case by calculation by using the computing device;
S3, calculating mean values, standard deviations, and coefficients of variation of geometric dimensions of the goods case through the second geometric dimension data of the goods case, and determining a goods case length L′, a goods case width B′, and a goods case height H′ through the mean value by using the computing device;
$${L}^{′} = {μ}_{L} = \frac{1}{n} {\sum }_{i = 1}^{n} {L}_{i} ; \\ {B}^{′} = {μ}_{B} = \frac{1}{n} {\sum }_{i = 1}^{n} {B}_{i} ; \\ {H}^{′} = {μ}_{H} = \frac{1}{n} {\sum }_{i = 1}^{n} {H}_{i} ;$$
wherein μ_{L} is a mean value of the transverse column spacing, μ_{B} is a mean value of the longitudinal column spacing, μ_{H} is a mean value of the floor heights, and n is the number of car body rack warehouses of different car factories;
S4, calculating a mean value μ_{G}, a standard deviation σ_{G}, and a coefficient of variation δ_{G} of the maximum stock weight of the goods case through the maximum stock weight of the goods case by using the computing device; and
S5, comparing each coefficient of variation with a coefficient of variation threshold δₘ, if each coefficient of variation is ≤δₘ, then the sample data of the car body rack warehouse meeting a normal distribution condition, and determining a process variable load Gₖ of a car body rack according to a high tantile with the reliability of 0.95 by using the computing device;
Gₖ=μ_{G}+1.645σ_{G},
wherein a process variable load of a rack warehouse may be accurately quantified, geometric dimensions of the goods case of the rack warehouse may be quantitatively analyzed, and optimization design is performed on design parameters of rack load supporting points through the method for analyzing the process load of the car body rack warehouse, thereby guiding a engineering design.

2. The method for analyzing the process load of the car body rack warehouse according to claim 1, further comprising the following steps:
S6, in a case where an action manner of the process variable load on the goods case comprising two manners, namely a concentrated load and a uniform load, respectively calculating a concentrated force Qₖ of a fulcrum and a standard value qₖ of a uniform line load through the following steps:
(1) calculating the concentrated force of the fulcrum according to the concentrated load;
$${Q}_{k} = {G}_{k} / 4 ;$$
(2) calculating a standard value of a uniform surface load according to the uniform load;
$${q}_{0 k} = \frac{{G}_{k}}{{B}^{′} {L}^{′}} ;$$
obtaining the standard value of the uniform line load to a bearing beam on both sides through derivative calculation of the surface load;
qₖ=q₀ₖB′/2; and
S7, performing optimization design, that is, determining an action position of the concentrated force with reference to the action of the uniform load according to a bending moment equivalence principle and/or a deflection equivalence principle.

3. The method for analyzing the process load of the car body rack warehouse according to claim 2, wherein a process of determining the action position of the concentrated force according to the bending moment equivalence principle comprises:
firstly, calculating a bending moment of the bearing beam in two manners of load transfer, namely the uniform load and the concentrated load;
(1) calculating a bending moment M_{Q} of the bearing beam according to the concentrated load;
$${M}_{Q} = {L}_{a} {Q}_{k} ;$$
wherein Lₐ is a distance between any leg and a rack column in a length direction of a body;
(2) calculating a bending moment M_{q} of the bearing beam according to the uniform load;
$${M}_{q} = \frac{{q}_{k} {L}^{′2}}{8} ;$$
and
then, making M_{Q}=M_{q}, obtaining a critical point of the bending moment by calculation, determining a reasonable action position of the concentrated force, at this time, the bending moment of the bearing beam corresponding to the concentrated force and the bending moment of the bearing beam corresponding to the uniform load being the same.

4. The method for analyzing the process load of the car body rack warehouse according to claim 2, wherein a process of determining the action position of the concentrated force according to the deflection equivalence principle comprises:
firstly, calculating a deflection of the bearing beam in two manners of load transfer, namely the uniform load and the concentrated load;
(1) calculating a deflection f_{Q} of the bearing beam according to the concentrated load;
$${f}_{Q} = \frac{{Q}_{k} {L}_{a} {L}^{′2}}{24 E I} ( 3 - 4 \frac{{L}_{a}^{2}}{{L}^{′2}} ) ;$$
(2) calculating a deflection f_{q} of the bearing beam according to the uniform load;
$${f}_{q} = \frac{5 {q}_{k} {L}^{′2}}{384 E I} ;$$
wherein E is an elastic modulus of the bearing beam, and I is a second moment of area of the bearing beam; and
then, making f_{Q}=f_{q}, obtaining a reasonable action position of the concentrated force by calculation, at this time, the deflection of the bearing beam corresponding to the concentrated force and the deflection of the bearing beam corresponding to the uniform load being the same.

5. The method for analyzing the process load of the car body rack warehouse according to claim 1, wherein the mean value μ_{G}, the standard deviation σ_{G}, and the coefficient of variation δ_{G} of the maximum stock weight of the goods case are respectively calculated according to the following formulas:
$${μ}_{G} = \frac{1}{n} {\sum }_{i = 1}^{n} {G}_{i} ; \\ {σ}_{G} = \sqrt{\frac{1}{n} {\sum }_{i = 1}^{n} {( {G}_{i} - {μ}_{G} )}^{2}} ; \\ {δ}_{G} = \frac{{σ}_{G}}{{μ}_{G}} ;$$
wherein Gᵢ is the maximum stock weight of the goods case in any car body rack warehouse.

6. The method for analyzing the process load of the car body rack warehouse according to claim 1, wherein the standard deviations and the coefficient of variations of the geometric dimensions of the goods case are respectively calculated according to the following formulas:
$${σ}_{L} = \sqrt{\frac{1}{n} {\sum }_{i = 1}^{n} {( {L}_{i} - {μ}_{L} )}^{2}} \\ {σ}_{B} = \sqrt{\frac{1}{n} {\sum }_{i = 1}^{n} {( {B}_{i} - {μ}_{B} )}^{2}} \\ {σ}_{H} = \sqrt{\frac{1}{n} {\sum }_{i = 1}^{n} {( {H}_{i} - {μ}_{H} )}^{2}} \\ {δ}_{L} = {σ}_{L} / {μ}_{L} ; \\ {δ}_{B} = {σ}_{B} / {μ}_{B} ; \\ {δ}_{H} = {σ}_{H} / {μ}_{H} ;$$
wherein σ_{L}, σ_{B}, and σ_{H} are the standard deviations of the transverse column spacing, the longitudinal column spacing, and the floor height respectively, and δ_{L}, δ_{B}, and δ_{H} are the coefficients of variation of the transverse column spacing, the longitudinal column spacing, and the floor height respectively.

7. The method for analyzing the process load of the car body rack warehouse according to claim 1, wherein the car body rack warehouse is provided with a plurality of goods cases, any goods case comprises rack columns and a bearing beam, two legs being uniformly distributed on the bearing beam, a pallet for placing the car body being arranged on the legs, and the pallet being centered relative to the bearing beam.
